(19) United States
(12) Patent Application Publication
(10) Pub. No.: US 2005/0185283 A1
(43) Pub. Date: Aug. 25, 2005

(54) Large aperture retro-reflector

(76) Inventors: Mikhail Belenkii, San Diego, CA (US); Donald Bruns, San Diego, CA (US); David Sandler, San Diego, CA (US)

Correspondence Address: John R. Ross;TREX ENTERPRISES, 10455 PACIFIC CENTER CT., SAN DIEGO, CA, 92121, US

(21) Appl. No.: 10/781,840

(22) Filed: Feb. 20, 2004

(51) Int. Cl. G01B 11/02; G02B 27/10

(52) U.S. Cl. 359/627

(57) ABSTRACT

A large clear aperture cat's eye retro-reflector system that improves the optical efficiency by two orders of magnitude over conventional cat's eye retro-reflectors. It achieves this increase by using a wide-angle lens design with a curved focal plane, so the entrance aperture is not limited by the design constraints of a solid glass sphere. Since light reflected from a retro-reflector increases as the fourth power of the reflector aperture, light reflected from the retro-reflector of the present invention is increased by two orders of magnitude as compared to the prior art cat's eye retro-reflector of conventional size. When used as a communication device, the retro-reflector is preferably modulated by a quantum well modulator providing very high speed communication. In preferred embodiments a moving quantum well modulator is placed near the focal plane, where the beam footprint is much smaller than the entrance aperture, effectively allowing a small modulator to modulate a large diameter beam. A tracking system tracks the source of interrogating beams and positions the small modulator to intersect the incoming beam near the focal plane where the beam footprint is very small.

This application relates to retro-reflectors and in particular to modulated retro-reflectors and to communication systems using them.

### BACKGROUND OF THE INVENTION

Retro-reflectors are well known and available including the corner cube retro-reflector and the cat's eye retro-reflector. When the aperture of one of these devices is illuminated by a light beam from a wide range of angles, a portion of the light beam is reflected in the general direction of its source. A large portion of light passing through a portion of the retro-reflector aperture is reflected toward the source with small divergence. This portion of the aperture is called the “clear aperture”. It is well known that a conventional cat's eye retro-reflector with a 120° field of view has a small clear aperture, and hence low optical efficiency.

Modulating retro-reflector devices play an integral role in several modern lasercom system concepts. These devices are useful for communication to and from the mobile stations where space, weight or electric power is very limited. Various approaches have been proposed for modulation devices, the most prominent of which is multiple quantum well technology. A multiple quantum well modulated retro-reflector is described in U.S. Pat. No. 6,154,299 which is incorporated herein by reference.

A basic design for conventional cat's eye retro-reflector with a 120 degree field of view is shown in FIG. 1. The full lens diameter is 13 mm, whereas the diffraction limited clear aperture diameter near the optical axis is only 2 mm, and it is 1 mm at the edge of the field of regard where the incident angle is ±60°. Thus, in the conventional cat's eye modulated retro-reflector the clear aperture is a small fraction of the full aperture. This greatly limits the optical efficiency of the retro-reflector. The retro-reflector may be used as a communication device by placing a modulator at location 4 as shown in FIG. 1.

For a single retro-reflector the received power is proportional to the clear aperture area. Therefore, P∝D², where D is the clear aperture diameter. Further, the divergence of the retro-reflected beam is proportional to φ∝λ/D where λ is the wavelength and the area S of the retro-reflected beam spot at the interrogator is proportional to

$${( \frac{λ}{D} )}^{2} .$$

Since the power received is inversely proportional to the beam spot area, the received power P at the interrogator depends on the clear aperture diameter as
P∝D⁴
Due to this fourth power law, when the clear aperture diameter is increased by a factor of 3.5, the received power is increased by a factor of (3.5)⁴=150. This increase of the optical efficiency is critically important for the MRR link because the received power at the interrogator reduces with the range as L⁻⁴.

What is needed is a much more efficient modulated retro-reflector.

### SUMMARY OF THE INVENTION

The present invention provides a large clear aperture cat's eye retro-reflector system that improves the optical efficiency by two orders of magnitude over conventional cat's eye retro-reflectors. It achieves this increase by using a wide-angle lens design with a curved focal plane, so the entrance aperture is not limited by the design constraints of a solid glass sphere. Since light reflected from a retro-reflector increases as the fourth power of the reflector aperture, light reflected from the retro-reflector of the present invention is increased by two orders of magnitude as compared to the prior art cat's eye retro-reflector of conventional size.

When used as a communication device, the retro-reflector is preferably modulated by a quantum well modulator providing very high speed communication. In preferred embodiments a moving quantum well modulator is placed near the focal plane, where the beam footprint is much smaller than the entrance aperture, effectively allowing a small modulator to modulate a large diameter beam. A tracking system tracks the source of interrogating beams and positions the small modulator to intersect the incoming beam near the focal plane where the beam footprint is very small. The lens design also keeps the region near the focal plane empty, providing a space to move the modulating chip along the top surface of a curved cat's eye mirror. The required motion is slow, with only coarse tracking required to keep the modulator within a 4° field of view. The motion of the moving modulator provides a 120° field of regard with an effective clear aperture equal to approximately 30 percent of the full aperture of the cat's eye at 0 degrees and about 20 percent of the cat's eye aperture at +/−60 degrees.

### BRIEF DESCRIPTION OF THE DRAWINGS

FIGS. 1A and 1B compares an embodiment of the present invention to a prior art cat's eye retro-reflector.

FIG. 2 shows a preferred embodiment of the present invention.

FIGS. 3A and 3B show arrays of a preferred embodiment of the present invention.

FIGS. 4A and 4B show features of a preferred embodiment of the present invention.

FIGS. 5A and 5B show features of another preferred embodiment of the present invention.

FIG. 6 shows features of another preferred embodiment of the present invention.

FIGS. 7 and 8 illustrate scintillation effects.

FIGS. 9A through 13B show effects of scintillation on communication beams.

FIGS. 14A through 18 show features of a preferred embodiment using a moving modulator.

FIG. 19 shows a tracking camera.

FIGS. 20A and 20B show an embodiment comprising an array of four retro-reflectors.

FIGS. 21 and 22 show features of the tracking camera.

FIGS. 23A and 23B compares an embodiment of the present invention to a prior art configuration.

FIGS. 24 and 25 are similar comparisons.

### DETAILED DESCRIPTION OF PREFERRED EMBODIMENTS

### Basic Large Aperture Retro-Reflector

A retro-reflector 16 representing a preferred embodiment of the present invention is shown in FIG. 1B and may be compared to a typical prior art cat's eye retro-reflector 2 shown in FIG. 1A.

Cat's Eye Retro-Reflector

The prior art cat's eye retro-reflector is comprised of two hemispheres 6 and 8 both of which are transparent to visible light. The outside surface 10 of bottom hemisphere 8 is coated to reflect visible light and the radii and material of the two hemispheres are chosen so that visible light illuminating the surface of hemisphere 6 is focused onto the reflective surface of hemisphere 8. The result is that visible light illuminating a portion 12 of the surface 14 of the top hemisphere 6 of cat's eye retro-reflector 2 from any angle between about +/−90 degrees from normal is retro-reflected back in the direction of its source. The portion 12 is referred to as the “clear aperture” of the cat's eye retro-reflector and represents about 15 percent of the diameter of the cat's eye device.

Large Aperture Retro-Reflector

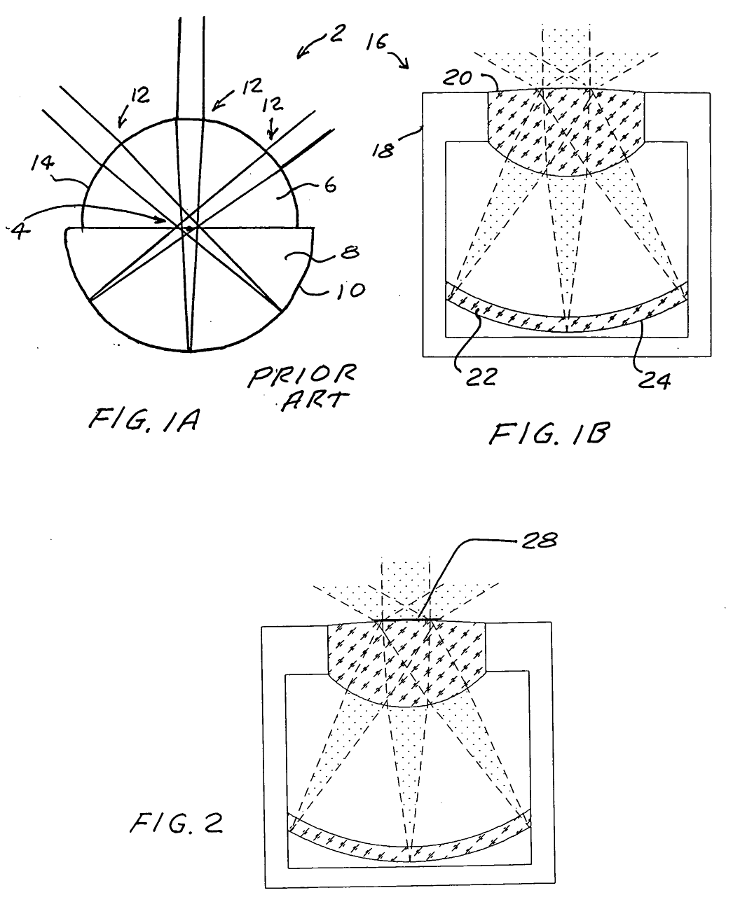

A large aperture retro-reflector according to the present invention is shown in FIG. 1B. This retro-reflector is comprised of a housing 18, a compound lens 20 and a curved mirror element 22. The lens is designed to focus light within a +/−60 degree field of regard onto a surface that is a portion 24 of an approximately spherical surface of mirror element 22. The portion 24 of the approximately spherical surface is made reflective by the deposition of a metal such aluminum on the back side of mirror element 24 which should correspond exactly (to best precision practicable, considering costs and application of the retro-reflector) to the focal surface of compound lens 20. The components of compound lens 20 and optical element 24 are preferable manufactured from transparent materials such as clear optical plastics or any of various types of optical glasses. The design of these two optical elements and their positions in housing 18 are preferably made using an optical design code such as Code 5 available from Optical Research Associates or the Zemax code available from Zemax Development Corporation. Applicants have developed a design for a large aperture as shown in FIG. 2B with a compound lens that has a focal length of approximately 90 mm. Reflective element 22 is preferably molded with an outside surface corresponding to the locus of the foci of lens 20. This surface is approximately but typically not exactly spherical. The back surface 24 is coated with a reflective element such as aluminum. This retro-reflector has a clear aperture of about 30 percent of the focal length of lens 20 at 0 degrees and about 20 percent of the focal length at +/−60 degrees.

In the directions of +/−60 degrees light retro-reflected from this retro-reflector is about 150 times as great as light retro-reflected from a conventional size prior art cat's eye retro-reflector. It may be utilized in almost all applications now using conventional cat's eye retro-reflectors such as highway signs. It may also be used as a communication device as describe below.

### Large Aperture Modulated Retro-Reflector

Prior art U.S. Pat. No. 6,154,299 referred to in the Background Section describes a cat's eye modulated retro-reflector with a quantum well modulator located at intersection of the two hemispheres comprising the prior art cat's eye device as shown at 4 in FIG. 1A. The present invention may also be adapted for use as a communication device by adding a modulator to the retro-reflector shown in FIG. 1B. Various embodiments of the present invention utilizing modulators are described below:

Modulator on Top Surface

In a preferred embodiment of the present invention shown in FIG. 2 a modulator 28 is placed on the top surface of lens 20 that intersects all retro-reflected beams. The modulator may be any one of many optical modulators available and well known in the prior art for modulating optical beams. Applicants' preferred modulator is the quantum well modulator described in the '299 patent that has been incorporated herein by reference.

Since the entire lens acts as a coherent reflector, diffraction patterns will be determined by the pattern diameter, not the diameter of individual apertures. Some vignetting will occur, but that will typically be tolerable, and will depend on the fill factor. The reader should note that this will not work for a corner-cube retro-reflector, since the incoming and outgoing paths are not aligned. For a refractive retro-reflector, as shown in FIG. 2, a tiled array of modulators can be placed at the lens aperture, and retro-reflection is maintained. This provides an ideal simulation of a return signal from a single large area retro-reflector with no moving parts. Using an array of smaller modulators, electrically driven in parallel, is a way to increase the bandwidth, since smaller modulators generally have faster response times.

Array of Large Aperture Modulated Retro-Reflectors

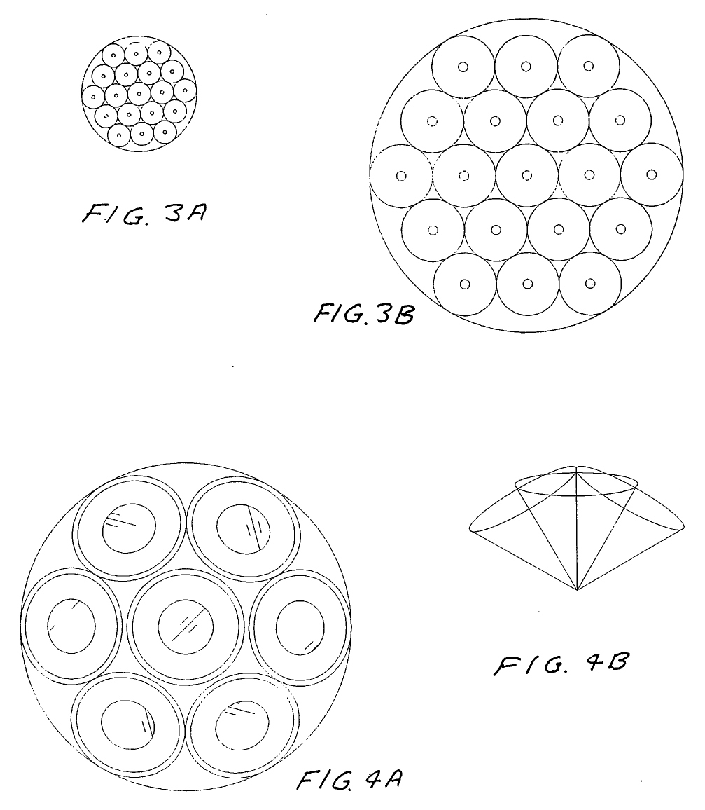

Another preferred embodiment of the present invention utilizes an array of the modulated retro-reflector shown in FIG. 2. Such arrays are portrayed in FIGS. 3A and 3B. Each of these two figures shows an array of 19 of the FIG. 2 modulated retro-reflectors tiled together to function as a single retro-reflector with a large aperture. In FIG. 3A the diameter of the retro-reflectors are 7 mm with 1 mm retro-reflecting aperture and in FIG. 3B the diameters are 20 mm with retro-reflecting apertures of about 3 mm. The entire assembly has an approximate diameter of 100 mm.

Tilted Retro-Reflector Arrays

FIGS. 4A and 4B depict an array of seven retro-reflectors, each having the basic FIG. 2 design. All of the retro-reflectors except the center retro-reflector are tilted 30 degrees with respect to the axis of the center retro-reflector as shown in FIG. 4B. Each of the retro-reflectors have a +/−60 degree field of view. Each has a 17.5-mm diameter lens and a retro-reflecting aperture of 10 mm. The entire array has a 100-mm diameter.

Moving Modulator

In a preferred embodiment of a large aperture modulated cat's eye type retro-reflector the modulator is a moving modulator as shown in FIGS. 5A and 5B. The instantaneous communications field of view of the retro-reflector is reduced as compared its total field of regard and the instantaneous communications field of view is scanned over the total field of regard by using moving light modulator 30 and a slow and coarse optical tracker 32. In this embodiment the modulator 30 is mounted on a first magnet 36 and moved into desired positions by a three-unit motor-pulley system 38A, B and C and a second magnet 40 on the back side of reflecting optic 22. A reduced instantaneous communications field of view allows Applicants to greatly reduce the size of the modulator relative to the clear aperture of the retro-reflector.

Because the instantaneous communications field of view is large enough (several degrees), only slow, very coarse tracking is required. The estimates show that to track the airborne interrogator transmitter moving at 1 degrees/sec (10 km*1 degrees/sec=390 MPH), the modulator velocity about 1.5 mm/sec ( 1/16″/sec) is needed. In order to compensate for the vehicle motion on the ground, when the vehicle turns at 90 degree in 4 seconds a higher modulator velocity of 28 mm/sec is required, which is still fairly slow motion. This reduces the complexity and cost of the tracking system.

### Array of Retro-Reflectors with Moving Modulators

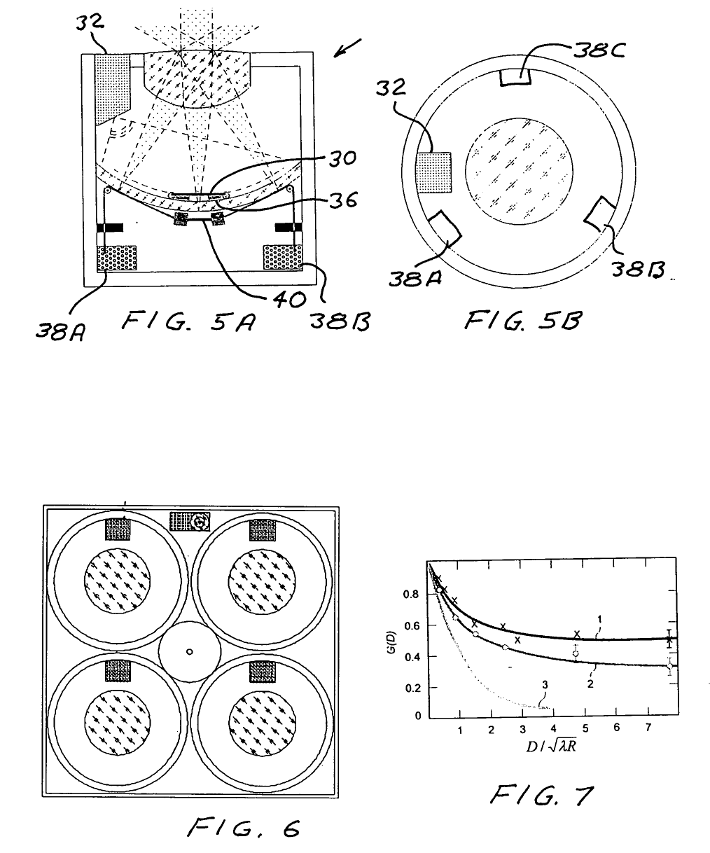

To increase the signal return at the airborne interrogator, another embodiment uses a small array of four of these FIGS. 5A and B units as one unit. Further, to mitigate the effect of turbulence-induced scintillation, the retro-reflectors in the array are separated at a distance Δl>l₁, r₀. An increased link margin and reduced scintillation level in the communication link allows Applicants to mitigate both the effect of turbulence and cirrus clouds. While each of the four units will use a moving modulator, a single tracking system is adequate to drive all of the modulator apertures. A top view of the array is shown in FIG. 6.

### Residual Turbulent Scintillation Effect

Because the retro-reflected beam in these retro-reflecting communication links propagates through the same atmospheric turbulence twice: first from the interrogator to the retro-reflector and then back to the interrogator, the scintillation in the retro-reflected beam exceeds the corresponding level in a one-way communication link when the transmitter and receiver are located at the different ends of the propagation path. In addition, the aperture averaging function in a retro-reflected beam does not gradually decrease with the receiving aperture diameter, but saturates at a constant level. The latter is due to a so-called residual turbulent scintillation effect. This effect occurs when the spatial correlation scale of intensity variations in the interrogator beam exceeds the retro-reflector diameter, l₁>D. Under this condition intensity variations in the interrogator beam caused by scintillation modulate the total retro-reflected flux. As a consequence, the received signal at the interrogator correlates at all points of the receiving aperture, and a large aperture receiver cannot average out these signal variations.

In a weak scintillation regime the intensity spatial correlation scale in a diverging laser beam is determined by the radius of the first Fresnel zone l₁=1.6\sqrt{λL}, where λ is the wavelength, and L is the range. For λ=1.55 μm and L=20 km the intensity correlation scale is l₁=28 cm, whereas it is l₁=20 cm for 10 km range. For the conventional cat's eye design, the clear aperture diameter is typically on the order of 1 cm. Therefore, l₁>>D, and the residual turbulent scintillation effect occurs in the retro-reflected beam.

FIG. 7 depicts the aperture averaging function measured with a small reflector, D<l₁, and reflector D≈l₁. The measured data for a small reflector, D<l₁, and reflector D≈l₁, is shown by crosses and circles, respectively. Curve 1 is the theoretical prediction for a small retro, curve 3 corresponds to a spherical wave on one-way path. Because of the saturation of the aperture averaging function, a large aperture receiver cannot reduce scintillation in a retro-reflected beam. Similar effect occurs in the retro-reflected link.

### Scintillation in the Retro-Reflected Link

In order to determine the link margin required to mitigate the impact of scintillation on the retro-reflected link, this effect needs to be quantified. Applicants evaluated the scintillation in the retro-reflected beam by using a wave-optics code. The following system parameters were used in the simulation: the wavelength λ=1.55 μm, the range L=20 km, the interrogator altitude H=10 km, the elevation angle ε=30°, the interrogator beam divergence 50 μrad, the MRR size 4 cm. The simulation grid size was 1024×1024, and the sample spacing was 5.7 mm. The atmospheric turbulence was modeled by using 9 phase screens. Two atmospheric turbulence models were employed: the HV_{5/7} turbulent model, which characterizes the night time turbulence, and a daytime turbulent model, where the refractive index structure characteristic near the ground is equal to Cₙ²=5×10⁻¹³ m^{2/3}. The atmospheric coherence diameter, or Fried parameter, for HV_{5/7} model and elevation angle ε=30° is equal to r₀=13 cm, whereas for daytime turbulence model r₀=8.6 cm.

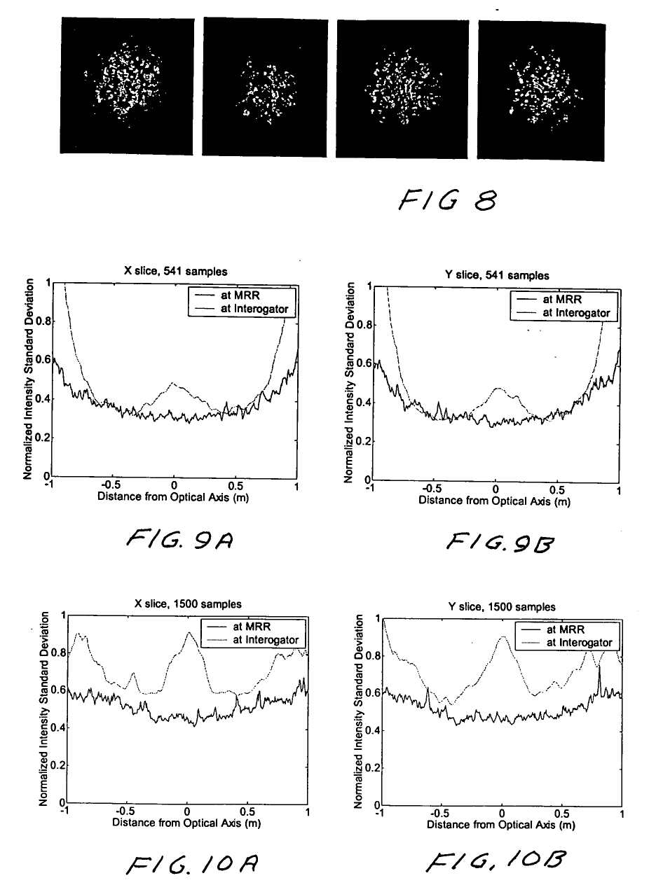

FIG. 8 depicts four turbulence induced scintillation pattern at the MRR in daytime turbulence. The frame size is 1.5 m×1.5 m. It is seen that the interrogator beam in the MRR link is broken into multiple speckles. The speckle size of the turbulence-induced scintillation is 15-20 cm, and it exceeds the typical clear aperture diameter of the cat's eye MRR (on the order of 1 cm).

FIGS. 9A and 9B depict respectively x and y slices of the normalized intensity standard deviation at the MRR and at the interrogator at 20 km range and elevation angle ε=30° at nighttime. The normalized standard deviation is shown versus distance from the optical axis. The scintillation in the retro-reflected beam at the interrogator exceeds the scintillation at the MRR (a one-way path). The normalized intensity standard deviation near the optical axis is σ₁=0.5. The peak near the optical axis is due to correlation of the intensity fluctuations in the interrogator beam and retro-reflected beam on a two-way path. The radius of the peak area is about 25 cm, which is consistent with the above estimates of the intensity spatial correlation scale, l₁.

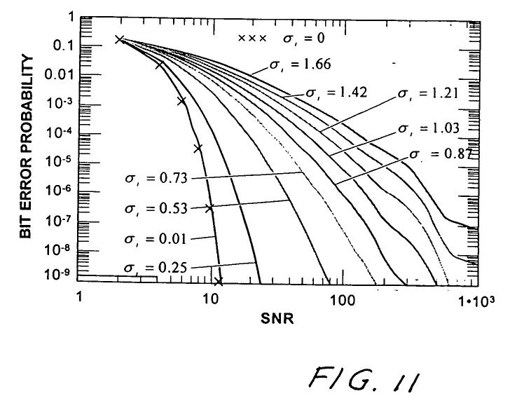

The x and y slices of the normalized intensity standard deviation at the retro-reflector and at the interrogator at 20 km range and elevation angle ε=30° in daytime turbulence is shown in FIGS. 10A and B. The normalized intensity standard deviation at the optical axis is σ₁=0.9. FIG. 11 give the signal to noise ratio needed to provide various bit error ratios at a range of standard deviations. According to FIG. 11, to mitigate the effect of scintillation in the retro-reflector link and achieve the BER=10⁻⁹ in daytime turbulence, the SNR=26 dB is required. In order to reduce the link margin needed to mitigate the effect of scintillation in the retro-reflector link, the scintillation level in the retro-reflected beam must be reduced. One can achieve this goal by using an array of these modulated retro-reflectors.

Mitigation of Turbulence-Induced Scintillation Using an Array of Retro-Reflectors Now we consider an array of retro-reflectors separated at a distance which exceeds the intensity spatial correlation scale in the interrogator beam, Δl≧l₁. The intensity in the retro-reflected wave is given by the sum

$${I}_{Σ} = {\sum }_{i = 1}^{N} {I}_{i} ,$$

where Iᵢ is the intensity in the beam retro-reflected by the i^{th} modulated retro-reflector, and N is the number of the retro-reflectors in the array. If intensities Iᵢ are statistically independent, then the scintillation in the retro-reflected wave is reduced.

The scintillation in the retro-reflected wave is reduced due to two effects. First, the scintillation in the interrogator beam is reduced because the optical signals acquired by each MRR separated by the distance Δl≧l₁ are uncorrelated. Second, the MRR array transmits back to the interrogator N spatially separated beams, which sample different turbulence volumes. Consequently, the scintillation is additionally reduced due to averaging over a finite angular size of the retro-reflector array, φ>1.6\sqrt{λ/L}. This effect is similar to the effect which reduces the scintillation for the planets as compared to that for the stars. Due to the above two effects the normalized intensity standard deviation in a retro-reflected wave is reduced proportionally to σ₁∝1/\sqrt{N}. The simulation results confirm this conclusion.

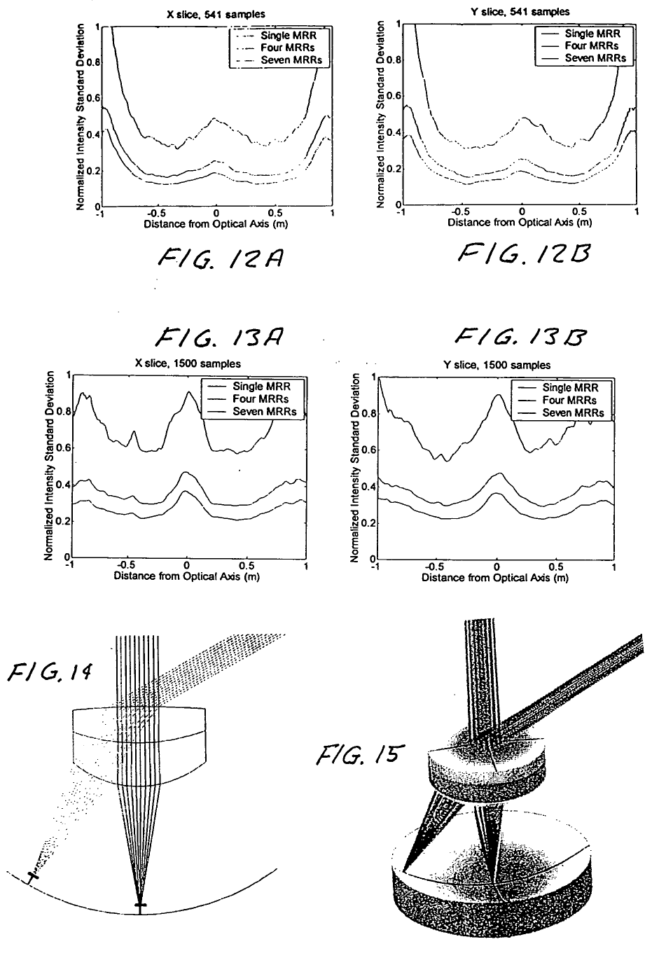

FIGS. 12A and B show the normalized intensity standard deviation at the interrogator for a single modulated retro-reflectors and an array of 4 and 7 retro-reflectors in night time turbulence. For a single modulated retro-reflector the normalized intensity standard deviation near the optical axis is σ₁=0.5, whereas for an array of 4 retro-reflectors it is σ₁=0.25. The normalized variance is reduced by a factor of 2.

FIGS. 13A and B depict the normalized intensity standard deviation at the interrogator in daytime turbulence. For a single modulated retro-reflector the normalized intensity standard deviation at the optical axis is σ₁=0.9, whereas for an array of 4 MRRs it is σ₁=0.45. Therefore, the normalized variance is reduced proportionally to 1/\sqrt{N}. The implication is that by using an array of retro-reflectors the scintillation level in the retro-reflected beam can be reduced. This reduces the link margin required for mitigation of scintillation in the retro-reflector link.

To mitigate the effect of scintillation for an array of 4 retro-reflectors in daytime turbulence only the SNR=16 dB is needed, whereas for a single MRR the SNR=26 dB is required. Furthermore, an array of retro-reflectors provides an additional SNR gain, as compared to a single retro-reflector. This allows us to mitigate the effect of cirrus clouds as well.

For an array of retro-reflectors, coherent interference of the light beams reflected from each retro-reflector is a concern. Coherent interference between the light beams reflected from each retro-reflector can cause additional intensity variations in the return beam and thus degrade the performance of the retro-reflector link. Therefore, this effect must also be mitigated. In order to eliminate coherent interference between the retro-reflected beams, each retro-reflector must be located in a different coherent volume of the interrogator beam. One can achieve this goal by separating the retro-reflectors in the transverse (perpendicular to the optical axis) or in the longitudinal, or beam propagation, direction.

The lateral coherence diameter, or Fried parameter, depends on the vertical profile of the refractive index structure characteristic Cₙ² (h) and elevation angle, ε, and it is given by

$${{r}_{0} [ 0.423 {( 2 π / λ )}^{2} {( sin ɛ )}^{- 1} {\int }_{{h}_{0}}^{H} {C}_{n}^{2} ( z ) ⅆ z ]}^{- 3 / 5}$$

where H is the altitude of the interrogator, and h₀ is the altitude of the array of MRRs. For HV_{5/7} turbulence model r₀=5 cm for λ=0.5 μm and propagation at the zenith. For λ=1.55 μm and ε=90′, the lateral coherence diameter is r₀=20 cm, whereas for ε=30′, r₀=13 cm. For daytime turbulent model the Fried parameter is r₀=8.6 cm. Thus, if the modulated retro-reflectors are separated at the distance Δl>20 cm, then each retro-reflector will be located in a different coherent volume and coherent interference between the retro-reflected beams will be eliminated.

In addition, the longitudinal coherence length,

$${l}_{c} = \frac{{λ}^{2}}{2 Δλ} ,$$

is determined by the wavelength, λ, and the laser line width, Δλ. For λ=1.55 μm and line width of Δλ=1.0 nm, the longitudinal coherence length is l_{c}=1.2 mm. Therefore, if the spacing between the retro-reflectors in the longitudinal direction exceeds 1.2 mm, the longitudinal coherence length, Δl₁>l_{c}, then each retro-reflector will be located in a different coherent volume. This will prevent coherent interference between the retro-reflected beams.

### Technical Details for the Dynamic Modulated Retro-Reflector Design

### Retro-Reflector Lens Design

The preliminary retroreflector design is based on a refractive optical system with a curved mirror at the focal plane, as shown in FIGS. 14A and B. The modulator is placed near the focal plane, so all the incoming light is concentrated into a small area. The instantaneous field of view of the optical system is determined by the modulator diameter and the lens focal length.

Assuming a 6 mm diameter modulator, and an 86 mm focal length, the instantaneous field of view is 4°. A reasonable focal ratio of F/2.4 leads to an input aperture of 36 mm. This is much larger than any cat's-eye design with a similar focal length. The field of regard for this simple doublet with a primary mirror is 120 degrees. FIGS. 14A and B show two ray bundles, one at 60 degrees off-axis, and one on-axis, are shown. The modulator near the mirror is not shown in the FIG. 14B view.

We have designed a preliminary system to show the essential details. The simple doublet shown in FIGS. 14A and B provides a diffraction-limited retro-reflection over a field larger than about 6 degrees (or 12 degrees with a 25 mm aperture). This field can be increased to about 120 degrees by adding additional optical surfaces and selecting appropriate optical glasses. For example, some fisheye lenses for 35 mm cameras have been designed with fields of view exceeding 180 degrees, all while maintaining color correction over the entire visible spectrum. The lens required here differs in that only monochromatic color correction is required, freeing up those surfaces and materials to aid in improving the wave front quality. In addition, instead of requiring a flat focal plane, we need a curved surface that is normal to the incoming beam. We can use an aspheric surface for this optic, so the lens focal length does not have to be fixed across the entire field of view. Finally, we do not require a fixed field stop; we will optimize the design to use as large an aperture as possible. The modulator position near the mirror is shown in FIG. 14A by a small black bar. Note that vignetting is minimized by keeping the bar parallel to the mirror surface. Not shown is the glass layer in front of the reflective surface.

The optimization merit function, which the ray tracing program automatically minimizes to find the best optical solution, will be weighted to emphasize the edge of the field of view. This is where the communication range is the longest (20 km) and the effective aperture is the smallest. For light coming in on-axis, the maximum range is only 10 km, so the retro-reflected signal is roughly 16 times stronger. If the optical design shows good performance on-axis, this will result in good communication under more adverse conditions. This type of tradeoff will be studied during lens optimization.

While an all-spherical design is desired, it might be necessary to place a simple asphere on some lens surfaces. Molded plastic or glass lenses are now routinely used in the commercial world, so this aspect should not restrict the design. The goal is to produce a design with the largest possible aperture, but some tradeoffs with manufacturability must always be considered.

The design should also be rugged and work over a wide temperature range. The spacing between the lenses and the mirror is critical. For best performance in this retro-reflecting system, the focus error should be on the order of the wavelength times the square of the focal ratio, or about 10 microns. This can easily be held with the appropriate spacer materials; Invar or silica, for example, are adequate. Depending on the actual glasses used in the final design, their effect on the focal length might also have to be considered in the overall compensation equation. Passive thermallization is always desired, but since some feedback from the airborne interrogator is possible, active thermallization might also be considered to further enhance performance.

Finally, if it is necessary to protect the reflecting surface from dust and contamination that might reduce retro-reflective efficiency, two alternatives are presented. The baseline approach is to make the mirror a second surface Mangin type. The mirror is not too large, so that BK7 can be used as a substrate, and a reflective coating applied to the back side. The reflection then goes through the glass, and any dust or contaminants on the first surface would be out of focus. Since that refractive surface is close to focus, its shape is not too critical, and a simple concentric surface should be acceptable. The back side reflector could be a gold coating, protected with a lacquer layer.

The alternative design, if the mirror is made of some low-expansion glass that does not transmit well, is to use a hard dielectric first surface mirror and use an anti-static type brush around the modulator aperture to keep the surface swept clean. As the modulator moves around the surface, the soft brush would sweep away dust, assuring that the reflection is always perfect.

### Modulator Design

Applicants' preferred modulator for the retro-reflectors shown in FIGS. 2 and 14A are 6 mm diameter modulator according to the description in the '299 patent referred to in the Background Section and incorporated herein by reference. These modulators are available from the Naval Research Laboratories. Other modulators may be used. The key requirements include a small package, low power consumption, and 45 MHz modulation capability.

Applicants' preferred embodiments includes optical tracking. Assuming the modulator diameter is 6 mm, the tracking requirements are easy to meet. An error of 1 mm would cause a negligible decrease in signal, so a precision tracking system is not required. The tracking camera presented in the next section can handle an angular tracking motion of 24 degrees per second. On the mirror surface, this corresponds to traversing the mirror surface in 5 seconds. For the mirror shown here, the maximum velocity would be only 28 mm/sec. Normally, the motion would be much slower.

Two mechanical designs have been considered: one uses cables to directly pull the modulator on hinged rails placed near the mirror; the alternate design uses magnetic coupling through the mirror to pull the modulator anywhere on the surface, without rails.

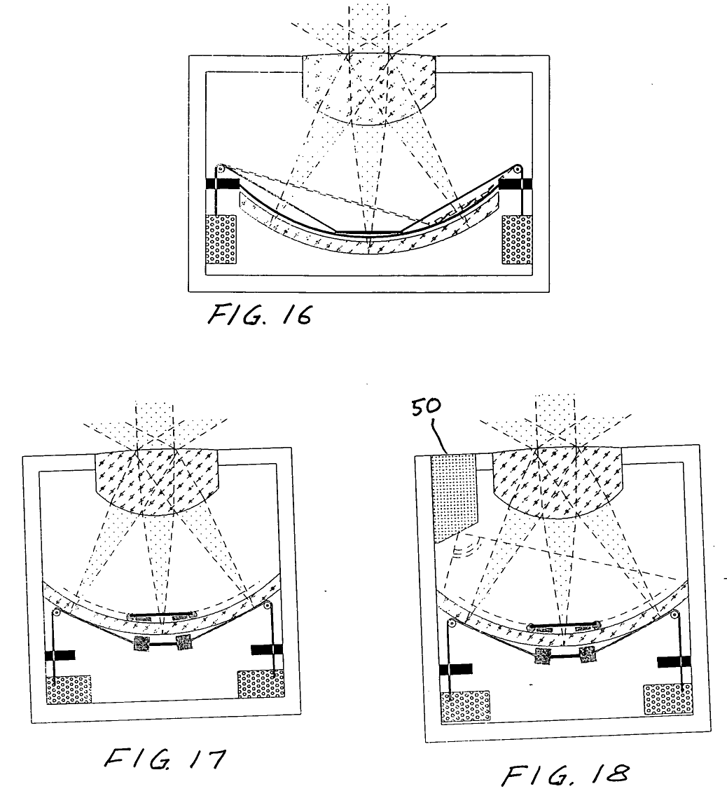

The baseline design uses rails to guide the modulator, as shown in FIG. 16. The modulator is shown as a 50 mm wide board, but the actual active aperture would only be large enough for the optical beam to pass through. Each end of the board is attached to cables connected to miniature motors set up like the mechanisms on common ink jet printers or older X-Y chart recorders. To allow access to any part of the mirror's surface, each end of the rail must be hinged. (Both rails are actually split into two parts so that the optical beam can pass between them.) The orthogonal rail will then be free to drive the modulator along the spherical surface. Since accuracy is not a major concern, the guides can be loose enough to prevent binding in any conceivable circumstance.

One advantage of this design is that the optics are never touched, preserving the optical alignment and the mirror surface for good retro-reflections. The main disadvantage is that the rails are somewhat difficult to design, or align. A rail-less system is shown in FIG. 17, where magnets act through the glass to move the modulator.

Taking advantage of the curved back surface, a few strong magnets can be positioned anywhere on the surface with a few opposing cables. A pair of rare earth magnets only 19 mm diameter can easily work through a substrate 50 mm thick, as long as the friction is not too large. The modulator board would be supported over the mirror by small rolling sapphire spheres or Teflon pads. Even if the mirror were a first surface design, durable hard-coated dielectric mirrors can easily survive this type of friction.

The advantage of this type of design is that it is more reliable. The primary disadvantage is the potential problem of scratches appearing on the reflective surface. Since all the mechanical parts are on the back side, however, the optical chamber can be assembled and sealed in a clean room, preserving the optical cleanliness. The tradeoffs between these motion control choices will be studied in more detail once the optical design has been finalized, in case that design discourages the Mangin mirror approach.

The modulator board is shown with no direct connections to signal or power supplies. In either option presented so far, a thin flexible cable could be used to connect the modulator board, or even a fiber optic cable. A flexible service loop could be located near the chamber walls, and springs could be used to keep the slack from getting in the way of the optical beam. In Applicants' preferred approach, however, Applicants are presenting a wireless link to provide both power and signal. This approach seems reasonable, especially since the requirements over such a short range seem simple to implement. This wireless option reduces risk and enhances reliability by reducing the number of moving or flexible components. The wireless transmitter is shown at 50 in FIG. 18 as the box in the upper left corner.

Getting a 45 MHz signal to the board is relatively simple, using a diffused laser source as a signal transmitter. A quick calculation shows that if a 3 mW-laser at 850 nm floods the optical chamber, a 10 mm silicon detector will pick up about 1 microwatt of laser power, or about 1000 times its noise level. This is more than enough margin to assure error-free signal transmission.

Inductive power coupling is used in a wide variety of consumer goods to provide power to electric razors and toothbrushes, as well as computer accessories. Normally, the wireless component runs on batteries that are kept charged while the unit is docked to the charging station. Since the modulator here may be turned on for a long period, we are assuming that our power requirements are continuous. The modulator board would only have a small capacitor storage cell that would operate the modulator for perhaps one or two seconds. This would reduce weight on the board, and by eliminating batteries, would enhance reliability. Power transfer over the entire range of the modulator motion is inefficient compared to close-coupled transfers, but the power requirements are expected to be so small that this inefficiency is not important.

An alternative to inductive coupling is using a solar cell on the board that picks up light from a bright LED. This is relatively inefficient because the light must be spread all across the field of regard, and only a small fraction can be captured. This light might also cause problems for the communication signal, although with appropriate filters, this could be a small effect. A few bright LEDs could provide 10 microwatts from a 40 mm² solar cell.

### IR Tracker Design

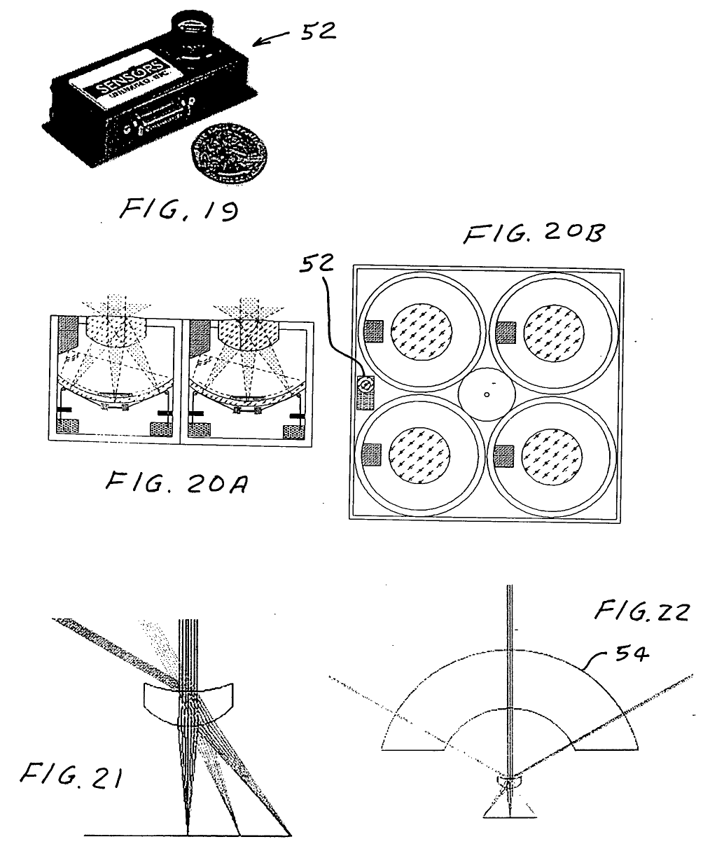

To keep a modulator on the line-of-sight with an interrogator, a tracking input is required. The baseline approach assumes that one tracker is adequate for the retro-reflector array and an IR tracking system is included. The tracker 52 for this proposal is based on a compact InGaAs digital camera with commercial specifications, shown in FIG. 19 together with a US quarter to indicate the size of the tracker unit. Its focal plane array is 320×256 pixels, so the each pixel corresponds to about ½ degree or about 8 pixels across the instantaneous field of view. That means that tracking need only be done to the nearest pixel. Since the image motion is very slow, the 60 Hz frame rate for this camera is more than adequate to provide closed loop tracking. Since the instantaneous field of view is 4 degrees, and an update rate of 60 Hz typically corresponds to a 6 Hz closed loop bandwidth, a maximum angular velocity that can be reliably tracked without forward-looking compensation is about 24 degrees per second. This more than satisfies the angular rate requirement.

There is plenty of room around the lens perimeters for the small tracking camera, so it fits nicely into the top of the assembly, as shown in FIG. 20. A lens for this camera has been designed. Since the receiver laser power is expected to be large, even in search mode, the tracking camera aperture can be very small. For example, if the search mode laser paints the ground with only 1 nW/cm², an aperture stop of 0.5 mm would provide an SNR of better than 20, more than adequate for tracking to within one pixel. For such a small aperture, a singlet lens made from a high index glass is perfectly acceptable, as shown in FIG. 21. At the edges of the 120 degree field of view, the ray traces show that the image spreads just about 25 microns, or one pixel diameter. If a larger aperture is desired, a doublet lens is required, but that would still probably be a very simple design.

FIG. 20 shows an array of four identical motorized light modulators, all run by the track output from the same IR tracking camera. This camera 52 is shown on the center left side of the assembly top view. In the center of the array is a conventional cat's-eye modulated retroreflector added to assist the interrogator to acquire the large aperture modulated retro-reflector array.

To prevent such a small aperture from being blocked by dirt or water, a cover 54 should be provided. FIG. 22 shows the type of cover that might be used. Using a concentric arrangement, the distortion over different field angles is negligible. Since only a small part of the window is used at any time, the optical quality of the window can be reduced to the point where a cast acrylic window may be used instead of a ground and polished glass. Since the outside of the window is so far from the lens aperture, even if a small spot gets dirty, a relatively small change in orientation will likely clear the spot. If the tracking algorithm projects position a little into the future, because of the 4 degree wide field of view of the modulated retroreflector, little down time due to aperture obscuration is anticipated.

The effect of direct sunlight onto the IR tracker focal plane is a concern. The baseline design already includes a filter to block all but IR light from hitting the focal plane, but since the angle of incidence is so large, a narrow band filter is probably difficult to manufacture. The sunlight that leaks though this wide filter has a total power far too small to cause damage, but the light may still be bright enough to cause blooming in the video signal. This would disrupt tracking, even when the searching laser is some distance away from the sun.

According to the vendor, their design does incorporate anti-blooming circuitry that should work for a signal saturated by over 1000×. Depending on the scenario, however, a factor of 1,000,000 might be desired. A proposed solution for this problem is to use a photo-chromic glass or plastic sheet just in front of the focal plane. Normally, this material is transparent, but when irradiated by sunlight (specifically, the ultraviolet rays from the sun), the material darkens. Sunglasses have been made from this material for many years, depending on the absorption of the free silver that is produced, to block sunlight. Since only a small portion of the focal plane will be irradiated by direct sunlight, only that portion of the focal plane will be affected, exactly as required. Since the sun would move only slowly, even in a traveling vehicle, much of the sunlight would always be blocked.

The intensity of sunlight on the focal plane is actually higher than for direct sunlight, due to the concentrating power of the lens. Even though such a small aperture is used, the intensity is still well above the threshold to darken the material. The magnitude of the blocking is not certain, however, so some simple experiments are required. Fortunately, the material is not affected by IR light, so even a strong interrogation beam (similar in power to the sun) will be unaffected.

Instead of glass, many new sunglasses use a plastic substrate with a thin photosensitive coating. Instead of silver, organic compounds are used that change absorption after irradiation. It is likely that infrared radiation would not be blocked, but this requires more testing. The advantage of this type of material is that it might be engineered especially for our application, including speeding up the response and recovery time. These are among the details that will be studied during the design optimization.

### Search and Interrogation Tracking Signal Augmentation

Applicants expect that airborne interrogators must be able to acquire the modulator retro-reflector on the ground using a retro-reflected return. In preferred systems with a moving modulator, the return is only visible when the optical tracking at the retro-reflector has begun and the modulator is located on the line-of-sight with the interrogator. The IR tracking camera has a flat focal plane and a small aperture, so it provides an insignificant return.

To provide an augmented return for acquisition of Applicants' large aperture array by the interrogator, a simple corner cube can be added. It is not modulated, and will simply appear as a strong glint. The IR tracker will detect the search beam, however, and will then move the modulator on the line-of-sight with the interrogator. As soon as the modulator is in place, the tracking signal will become modulated, positively eliminating a false alarm. The time to move the modulator into position may require a few seconds, but this may not be of any consequence. To reduce the background noise once the interrogator has locked onto the system, a shutter might be used in front of the corner cube to block its reflection. Another alternative would be to use a small aperture cat's eye modulated retro-reflector. Applicants' calculations show that the maximum aperture will be only 11 mm, far too small for a 45 MHz communication link, but more than adequate to provide a low bandwidth modulated acquisition signal. This cat's eye was shown in the center of FIG. 20.

### Comparison with prior Art Cat's Eye Modulated Retro-Reflectors

For the static cat's eye modulated retro-reflectors with a field of regard of 120 degrees the clear aperture diameter is 10.3 mm, whereas the full aperture diameter is 96 mm. By using a moving modulator and an optical tracker, the clear aperture diameter in the present invention is increased to 36 mm. This increases an optical efficiency of the retro-reflector, as compared to the prior art cat's eye retro-reflector by a factor of 150. An array of four large aperture retro-reflectors of the type described above has the same optical efficiency as an array of 600 prior art static cat's eye modulated retro-reflectors.

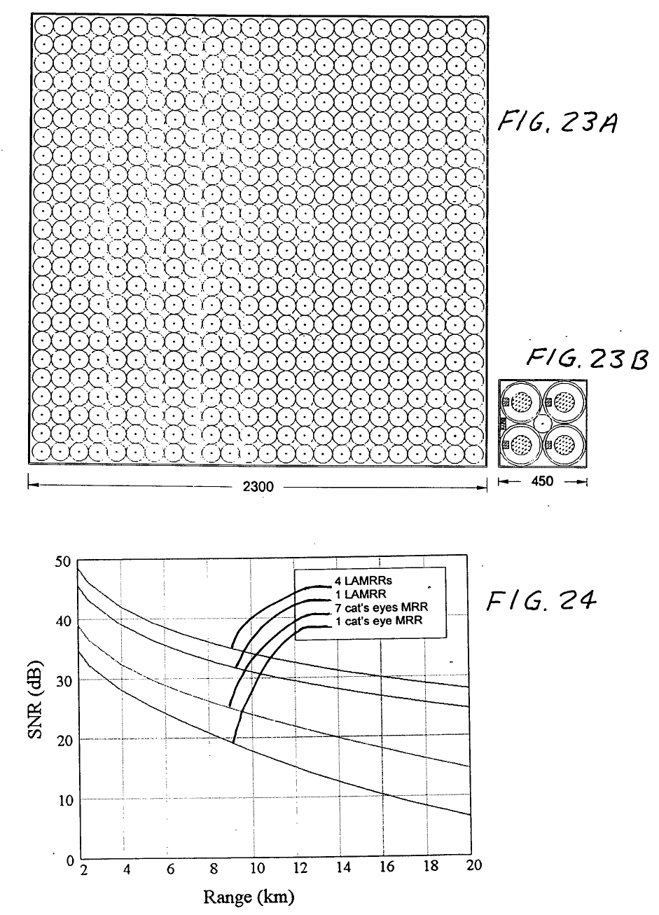

FIG. 23A depicts an array of 576 prior art static cat's eye modulated retro-reflectors and FIG. 23B shows an array of four large aperture modulated retro-reflectors of the present invention, which have approximately the same optical efficiency. From this picture it is clear that the retro-reflectors of the present invention dramatically reduces the system complexity as well as its form factor.

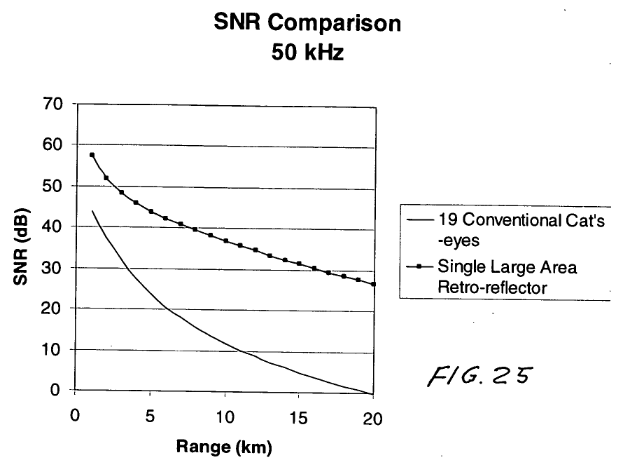

FIG. 24 shows the SNR versus range for single cat's eye modulated retro-reflector, a single large aperture modulated retro-reflector, and an array of 4 large aperture retro-reflectors and array of 7 cat's eye modulated retro-reflectors. The estimates are obtained for 5 watts laser power at the interrogator, 30 degrees elevation angle, 30 mm transmitting aperture diameter and 60 mm receiver diameter. Finally, FIG. 25 compares the SNR of the configuration shown in FIG. 4A with an array of 19 prior art modulated cats eye retro-reflectors of similar size. From FIG. 24 it is seen that a single large aperture modulated retro-reflector provides an increase of 25 dB over an array of 19 cat's eye modulated retro-reflectors at 10 km range.

While there have been shown what are presently considered to be preferred embodiments of the present invention, it will be apparent to those skilled in the art that various changes and modifications can be made herein without departing from the scope and spirit of the invention. For example, the inside surface of mirror element 22 shown in FIGS. 1B and 2 could be made reflective with an aluminum coating in which the lens element 20 should be designed to focus light in the field of regard on the inside surface. The above description describes three-dimensional retro-reflector in which the field of regard and fields of view are conical. Persons skilled in his art will recognize that in some applications a substantially two-dimensional retro-reflector could be provided based on the teachings of this specification by substituting a cylindrical lens for lens 20 and a substantially cylindrical mirror element for mirror element 22 in the FIGS. 1B and 2 devices. Persons skilled in the art will also recognize that by restricting the field of regard, the clear aperture can be increased and the retro-reflection efficiency can be increased. Therefore in some applications the field of regard may be reduced such as to +/−20 degrees or +/−30 degrees.

Thus, the scope of the invention is to be determined by the appended claims and their legal equivalents.

1. A large aperture retro-reflector defining a clear aperture, said retro-reflector comprising:
A) a housing,
B) a compound lens attached to said housing, said lens defining a focal surface represented by a locus of focal points for beams of light illuminating said retro-reflector from a range of directions of at least +/−20 degrees,
C) a mirror element having a reflective surface co-located with or approximately co-located with said focal surface.

2. The retro-reflector as in claim 1 wherein at least 75 percent of light in a predetermined wavelength range illuminating said aperture of said retro-reflector from a light source, approximating a point source, within said range of direction is reflected back toward said light source with a divergence of less than +/−1.0 degrees.

3. The retro-reflector as in claim 1 wherein at least 90 percent of light in a predetermined wavelength range illuminating said aperture of said retro-reflector from a light source, approximating a point source, within said range of direction is reflected back toward said light source with a divergence of less than +/−0.001 degrees.

4. The retro-reflector as in claim 1 and also comprising a modulator positioned so as to modulate light beams from an interrogating light source located at an interrogation location and a modulating means for modulating said modulator to impose communication signals on said interrogating beam to permit communication from said retro-reflector back to the interrogation location.

5. The retro-reflector as in claim 4 wherein said modulator in a quantum well modulator.

6. The retro-reflector as in claim 4 wherein said clear aperture defines a diameter and said lens defines a diameter and the diameter of the clear aperture is at least ⅓ the lens diameter.

7. The retro-reflector as in claim 1 and also comprising a modulator positioned so as to modulate light beams from an interrogating light source located at an interrogation location and a modulating means for modulating said modulator to impose communication signals on said interrogating beam to permit communication from said retro-reflector back to the interrogation location.

8. The retro-reflector as in claim 7 wherein said modulator is a quantum well modulator.

9. The retro-reflector as in claim 3 wherein said clear aperture defines a diameter and said lens defines a diameter and the diameter of the clear aperture is at least ⅓ the lens diameter.

10. The retro-reflector as in claim 4 wherein said lens defines a focal surface represented by a locus of focal points for beams of light illuminating said retro-reflector from a range of directions of at least +/−60 degrees.

11. The retro-reflector as in claim 4 wherein said modulator is positioned between said lens and said mirror element and is movable with respect to the lens and the mirror element and further comprising:
A) a tracking device for tracking a source of interrogating light beams at an interrogating location,
B) a modulator position control means for positioning said modulator across an interrogating light beam from said source, and
C) a modulating means for modulating said modulator to impose signals on said interrogating beam to permit communication from said retro-reflector back to the interrogation location.

11. An array of retro-reflectors each retro-reflector defining a clear aperture, and each of said retro-reflectors comprising:
A) a housing,
B) a compound lens attached to said housing, said lens defining a focal surface represented by a locus of focal points for beams of light illuminating said retro-reflector from a range of directions of at least +/−20 degrees,
C) a mirror element having a reflective surface co-located with or approximately co-located with said focal surface,
D) a modulator positioned so as to modulate light beams from an interrogating light source located at an interrogation location and a modulating means for modulating said modulator to impose communication signals on said interrogating beam to permit communication from said retro-reflector back to the interrogation location.

12. The array of retro-reflectors as in claim 11 wherein all but one of said retro-reflectors are tilted with respect to one un-tilted retro-reflector.
